(19) United States
(12) Patent Application Publication
(10) Pub. No.: US 2014/0261066 A1
(43) Pub. Date: Sep. 18, 2014

(54) Retractable Rail Wheels for a Road/Rail Vehicle

(71) Applicant: BRANDT ROAD RAIL CORPORATION, Regina (CA)

(72) Inventors: Josh Dumalski, Regina (CA); Kyle Lockert, Regina (CA)

(21) Appl. No.: 13/804,823

(22) Filed: Mar. 14, 2013

(51) Int. Cl. B60F 1/00

(52) U.S. Cl. CPC B60F 1/00
USPC 105/215.2

(57) ABSTRACT

A road/rail vehicle apparatus comprising a vehicle frame, and a rail axle with rail wheels rotatably attached to ends thereof. The rail axle is attached to the vehicle frame by a parallel link assembly. An airbag mounting plate is fixed to a link arm of the parallel link assembly, and an airbag is attached at a lower end thereof to the airbag mounting plate and attached at an upper end thereof to the vehicle frame. An airbag control is operative to vary air pressure inside the airbag, and as the airbag expands and contracts as the rail axle moves up and down the end plates of the airbag remain substantially parallel to each other increasing the range of travel and reducing lateral stresses on the airbag.

### FIELD

This disclosure relates to the field of vehicles for use on railway tracks and conventional roads and highways, and in particular a mechanism for raising and lowering the front rail wheels.

### BACKGROUND

It is known to adapt vehicles such as conventional highway tractors for use on rails by providing retractable rail wheels which are lowered to maintain the position of the vehicles on the railway tracks and are raised for road use of the vehicle.

For example U.S. Pat. No. 5,103,740 to Masse and U.S. Pat. No. 5,868,078 to Madison disclose road/rail vehicles. U.S. Pat. No. 5,016,544 to Woollam discloses a convertible road/rail power vehicle with road wheels and retractable front, middle, and rear rail wheels for moving rail cars. Drive is provided by a set of retractable solid rubber rail wheels near the longitudinal center of gravity near the middle of the vehicle.

U.S. Pat. No. 6,976,432 to Jacob discloses a railcar moving vehicle with retractable rail wheels for guiding the vehicle on rails, and rubber-tired drive wheels that provide drive for both road and rail use. The rubber-tired drive wheels are configured to support the vehicle on a roadway in highway mode, and to contact the rails in rail mode such that the same road wheels drive the vehicle in both the rail and road modes.

Brandt Road Rail Corporation of Regina, Canada manufactures road/rail vehicle with front and rear rubber road wheels and front and rear retractable steel rail wheels where, like the Jacob vehicle described above, the rubber rear wheels provide drive for both road and rail use. With the Jacob and Brandt vehicles, the front and rear rail wheels are mounted on pivot arms that are pivotally attached to the vehicle frame. In rail mode the front rail wheels are lowered and the front road wheels raised above the rails. The rear rail wheels are lowered to engage the rails to keep the vehicle on the rails, but a significant portion of the weight of the rear end of the vehicle remains on the rubber rear wheels to provide traction to move the vehicle and rail cars attached to it. An air bag suspension system raises and lowers the front and rear rail wheels and also controls the proportion of vehicle weight that is carried by the rear rail wheels and the rear drive wheels.

The rear wheels only move down to engage the wheels and the rear rubber wheels remain in contact with the rails. The front rail wheels however must move downward farther in order to raise the front road wheels above the rails. The longer range of travel required by the front pivot arm causes significant deformation of the airbag which inflates and deflates to move the front pivot arm, causing wear. In some vehicles the range of travel required to raise the front road wheels above the rails cannot be obtained with the airbag alone.

When the front rail wheels are raised in the road travel position, the weight of the front end of the vehicle is carried on the front wheels through a spring suspension that bends in response to the weight. As the front rail wheels move down into the rail travel position, the frame moves upward however the springs must unbend before the front wheels move above the rails as required. To reduce the required range of travel of the front rail wheels, the spring suspension may be pinned to the frame when the front rail wheels are raised and the springs are bent, such that the front road wheels move upward directly with the frame. Pinning the front road wheels and/or spring suspension is inconvenient and time consuming.

### BRIEF SUMMARY

The present disclosure provides a retractable rail wheel apparatus for a road/rail vehicle that overcomes problems in the prior art.

In a first embodiment the present disclosure provides a road/rail vehicle apparatus comprising a vehicle frame, and a rail axle with right and left rail wheels rotatably attached to corresponding right and left ends of the rail axle. At least one parallel link assembly comprises a lower arm pivotally attached at a first end thereof to the vehicle frame about a lower frame pivot axis and extending in a direction substantially parallel to an operating travel direction of the vehicle frame, and attached at an opposite second end thereof the rail axle, an upper arm pivotally attached at a first end thereof to the vehicle frame about an upper frame pivot axis above the lower frame pivot axis, and a link arm pivotally attached at a lower end thereof to the lower arm at a lower link pivot axis and pivotally attached at an upper end thereof to a second end of the upper arm at an upper link pivot axis. A distance between the upper and lower link pivot axes is substantially equal to a distance between the upper and lower frame pivot axes, and a distance between the lower link and lower frame pivot axes is substantially equal to a distance between the upper link and upper frame pivot axes. An airbag mounting plate is fixed to the link arm, and an airbag is attached at a lower end thereof to the airbag mounting plate and attached at an upper end thereof to the vehicle frame. An airbag control is operative to vary air pressure inside the airbag.

In a second embodiment the present disclosure provides a road/rail vehicle apparatus comprising a vehicle frame and front road wheels mounted under a front end portion of the vehicle frame and supporting the front end portion of the vehicle for travel on roads in a road mode. A front rail axle with right and left front rail wheels rotatably attached to corresponding right and left ends of the front rail axle supports the front end portion of the vehicle for travel on rails in a rail mode. Right and left parallel link assemblies are attached to corresponding right and left sides of the vehicle frame and to corresponding right and left end potions of the front rail axle. Each parallel link assembly comprises a lower arm pivotally attached at a rear end thereof to the vehicle frame about a lower frame pivot axis and extending forward to an opposite front end thereof attached to the front rail axle; an upper arm pivotally attached at a rear end thereof to the vehicle frame about an upper frame pivot axis above the lower frame pivot axis and extending forward from the upper frame pivot axis to a front end thereof; a link arm pivotally attached at a lower end thereof to the lower arm at a lower link pivot axis and pivotally attached at an upper end thereof to the front end of the upper arm at an upper link pivot axis; wherein a distance between the upper and lower link pivot axes is substantially equal to a distance between the upper and lower frame pivot axes, and a distance between the lower link and lower frame pivot axes is substantially equal to a distance between the upper link and upper frame pivot axes, and an airbag mounting plate fixed to the link arm. An airbag is attached at a lower end thereof to the airbag mounting plate and is attached at an upper end thereof to the vehicle frame, and an airbag control is operative to increase air pressure inside the airbag to expand the airbag and move the rail axle down such that the front road wheels are raised above the rails when in the rail mode.

The parallel link assembly provides an increased range of travel and reduces lateral stresses on the airbag.

### BRIEF DESCRIPTION OF THE DRAWING

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of a road/rail vehicle of the prior art in the rail mode where the rail axle is lowered;

FIG. 2 is a schematic side view of the front rail axle lifting arm and airbag of the vehicle of FIG. 1 in the road mode where the rail axle is raised;

FIG. 3 is a schematic side view of the front rail axle lifting arm and airbag of the vehicle of FIG. 1 in the rail mode where the rail axle is lowered;

FIG. 4 is a side view of an embodiment of a road/rail vehicle apparatus of the present disclosure in the rail mode where the rail axle is lowered;

FIG. 5 is a schematic side view of the parallel link assembly and airbag for moving the front rail axle of the embodiment of FIG. 4, shown in the rail mode where the rail axle is lowered;

FIG. 6 is a schematic side view of the parallel link assembly and airbag for moving the front rail axle of the embodiment of FIG. 4, shown in the road mode where the rail axle is raised;

FIG. 7 is a schematic front view of the vehicle frame, parallel link assemblies, and rail axle and wheels of the embodiment of FIG. 4 shown in the rail mode where the rail axle is lowered.

### DETAILED DESCRIPTION

FIG. 1 illustrates a road/rail vehicle 1 of the prior art comprising a vehicle frame 3 and front road wheels 5 mounted under a front end portion of the vehicle frame 3 and supporting the front end portion of the vehicle 1 for travel on roads in a road mode. A front rail axle 7 with front rail wheels 9 rotatably attached to right and left ends of the front rail axle 7 support the front end portion of the vehicle 1 for travel on rails 11 in the rail mode shown in FIG. 1.

In the prior art vehicle 1 the front rail axle 7 is moved down by directing pressurized air into an airbag 13 that is attached at an upper end thereof to the vehicle frame 3 and is attached at a lower end thereof to a pivot arm 15. The pressurized air expands the airbag 13 and pushes the front rail axle 7 and wheels 9 downward to raise the front road wheels 5 above the rails 11. FIG. 2 schematically illustrates the airbag 13 in the road mode where the pivot arm 15 is raised so that the front rail wheels 9 are above the road surface. An actuator, such as an air or hydraulic cylinder is typically used to raise the rail wheels to the road mode, and is not illustrated. FIG. 3 schematically illustrates the airbag 13 in the rail mode where the pivot arm 15 is pushed down so that the front rail wheels 9 engage the rails as shown in FIG. 1.

It can be seen that the top and bottom end plates 13A, 13B of the airbag 13 are not parallel but are oriented at an angle to each other in both the road and rail modes. This non-parallel orientation causes lateral stresses on the airbag 13 as it expands and contracts, and also limits the range of movement. It thus may be necessary to pin the front road wheels 5 to the vehicle frame 3 in order to raise the wheels 5 above the rails as illustrated in FIG. 1.

FIG. 4 illustrates a road/rail vehicle apparatus 101 of the prior art comprising a vehicle frame 103 and front road wheels 105 mounted under a front end portion of the vehicle frame 103 and supporting the front end portion of the vehicle apparatus 101 for travel on roads in a road mode. A front rail axle 107 with front rail wheels 109 rotatably attached to right and left ends of the front rail axle 107 support the front end portion of the apparatus 101 for travel on rails 111 in the rail mode shown in FIG. 4. In the apparatus 101, right and left parallel link assemblies 120, as schematically illustrated in FIGS. 5-7, are attached to corresponding right and left sides of the vehicle frame 103 and to corresponding right and left end potions of the front rail axle 107 and are operative to push the front rail axle 107 and wheels 109 down against the rails 111 with airbags 113.

Each parallel link assembly 120 comprises a lower arm 121 pivotally attached at a rear end thereof to a bracket 123 fixed to the vehicle frame 103 about a lower frame pivot axis LF and extending forward to an opposite front end thereof attached to the front rail axle 107. An upper arm 125 is pivotally attached at a rear end thereof to the bracket 123 fixed to the vehicle frame 103 about an upper frame pivot axis UF above the lower frame pivot axis LF and extends forward from the upper frame pivot axis UF to a front end thereof. A link arm 127 is pivotally attached at a lower end thereof to the lower arm 121 at a lower link pivot axis LL and is pivotally attached at an upper end thereof to the front end of the upper arm 125 at an upper link pivot axis UL. The distance between the upper and lower link pivot axes UL, LL is substantially equal to a distance between the upper and lower frame pivot axes UF, LF, and the distance between the lower link and lower frame pivot axes LL, LF is substantially equal to the distance between the upper link and upper frame pivot axes UL, UF such that the upper and lower arms 121, 125, the link arm 127 and the pivot axes UF, LF on the bracket 123 form a parallelogram.

In such a parallel link assembly 120, the link arm 127 remains in the same orientation as it moves up and down. An airbag mounting plate 129 is fixed to the link arm such that same is oriented horizontally and the airbag mounting plate 129 will therefore also remain horizontal at it moves up and down. Front and rear airbags 113F, 113R are attached at lower end plates 113B thereof to the airbag mounting plate 129 and are attached at upper end plates 113A thereof to an frame mounting plate 131 that is fixed to the vehicle frame 103 parallel to the airbag mounting plate 129. In FIG. 6 the rear airbag 113R is not shown so other parts may be seen more clearly. The lower end plate 113B of the front airbag 113F is attached to the airbag mounting plate 129 forward of the lower link pivot axis LL and the lower end plate 113B of the rear airbag 113R is attached to the airbag mounting plate 129 rearward of the lower link pivot axis LL such that forces are generally balanced on the link arm 127. The upper end plates 113A of the airbags 113 are attached to the frame mounting plate 131 directly above, and parallel to, the corresponding lower end plates 113B.

Thus as the parallel link assembly 120 moves between the rail mode of FIG. 5 and the road mode of FIG. 6, the upper and lower end plates 113A, 113B remain parallel to each other. The range of travel of the airbags 113 is thus not limited as in the prior art airbags 13 illustrated in FIGS. 2 and 3, and there is no lateral stress on the airbags 113.

An airbag control 133 located in the vehicle operator station 135 is operative to increase air pressure inside the airbags 113 to expand the airbags and move the rail axle 107 down such that the front road wheels 105 are raised above the rails 111 when in the rail mode illustrated in FIG. 4. An actuator as known in the prior art is used to move the assembly 120 up and move the rail axle 107 to the raised road mode, and is not illustrated.

FIG. 7 schematically illustrates a front view showing the right and left parallel link assemblies 120R, 120L mounted on the vehicle frame 103, and the rail axle 107 and rail wheels 109 attached to the assemblies 120R, 120L. Also shown is a rock shaft 137 extending from the right parallel link assembly 120R to the left parallel link assembly 120L. The rock shaft 137 is rotatably mounted to the brackets 123 fixed to the vehicle frame 103 and provided the lower frame axis LF of the right and left parallel link assemblies 120R, 120L.

The parallel link assembly 120 thus provides a mechanism for moving the rail axle 107 between the road and rail modes with an increased range of travel, and reduced lateral stresses on the airbags.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A road/rail vehicle apparatus comprising:
a vehicle frame;
a rail axle and right and left rail wheels rotatably attached to corresponding right and left ends of the rail axle;
at least one parallel link assembly comprising:
a lower arm pivotally attached at a first end thereof to the vehicle frame about a lower frame pivot axis and extending in a direction substantially parallel to an operating travel direction of the vehicle frame, and attached at an opposite second end thereof the rail axle;
an upper arm pivotally attached at a first end thereof to the vehicle frame about an upper frame pivot axis above the lower frame pivot axis;
a link arm pivotally attached at a lower end thereof to the lower arm at a lower link pivot axis and pivotally attached at an upper end thereof to a second end of the upper arm at an upper link pivot axis;
wherein a distance between the upper and lower link pivot axes is substantially equal to a distance between the upper and lower frame pivot axes, and a distance between the lower link and lower frame pivot axes is substantially equal to a distance between the upper link and upper frame pivot axes; and
an airbag mounting plate fixed to the link arm;
an airbag attached at a lower end thereof to the airbag mounting plate and attached at an upper end thereof to the vehicle frame; and
an airbag control operative to vary air pressure inside the airbag.

2. The apparatus of claim 1 wherein the rail axle is a front rail axle and wherein the lower arm extends forward from the lower frame pivot axis.

3. The apparatus of claim 1 wherein the airbag mounting plate is oriented substantially horizontally.

4. The apparatus of claim 3 comprising front and rear airbags attached at lower ends thereof to the airbag mounting plate and attached at upper ends thereof to the vehicle frame.

5. The apparatus of claim 4 wherein the front airbag is forward of the lower link pivot axis and the rear airbag is rearward of the lower link pivot axis.

6. The apparatus of claim 1 comprising right and left parallel link assemblies attached to corresponding right and left end portions of the rail axle, and right and left airbags attached to the corresponding right and left parallel link assemblies and the frame, and wherein the airbag control is operative to vary air pressure inside the right and left airbags.

7. A road/rail vehicle apparatus comprising:
a vehicle frame and front road wheels mounted under a front end portion of the vehicle frame and supporting the front end portion of the vehicle for travel on roads in a road mode;
a front rail axle and right and left front rail wheels rotatably attached to corresponding right and left ends of the front rail axle and supporting the front end portion of the vehicle for travel on rails in a rail mode;
right and left parallel link assemblies attached to corresponding right and left sides of the vehicle frame and to corresponding right and left end potions of the front rail axle, each parallel link assembly comprising:
a lower arm pivotally attached at a rear end thereof to the vehicle frame about a lower frame pivot axis and extending forward to an opposite front end thereof attached to the front rail axle;
an upper arm pivotally attached at a rear end thereof to the vehicle frame about an upper frame pivot axis above the lower frame pivot axis and extending forward from the upper frame pivot axis to a front end thereof;
a link arm pivotally attached at a lower end thereof to the lower arm at a lower link pivot axis and pivotally attached at an upper end thereof to the front end of the upper arm at an upper link pivot axis;
wherein a distance between the upper and lower link pivot axes is substantially equal to a distance between the upper and lower frame pivot axes, and a distance between the lower link and lower frame pivot axes is substantially equal to a distance between the upper link and upper frame pivot axes; and
an airbag mounting plate fixed to the link arm;
an airbag attached at a lower end thereof to the airbag mounting plate and attached at an upper end thereof to the vehicle frame; and
an airbag control operative to increase air pressure inside the airbag to expand the airbag and move the rail axle down such that the front road wheels are raised above the rails when in the rail mode.

8. The apparatus of claim 7 wherein the airbag mounting plate is oriented substantially horizontally and comprising front and rear airbags attached at lower ends thereof to the airbag mounting plate and attached at upper ends thereof to the vehicle frame.

9. The apparatus of claim 8 wherein the lower end of the front airbag is attached to the airbag mounting plate forward of the lower link pivot axis and the lower end of the rear airbag is attached to the airbag mounting plate rearward of the lower link pivot axis.

10. The apparatus of claim 9 wherein the upper ends of the front and rear airbags are attached to the vehicle frame mounting directly above the corresponding lower ends, and such that upper end plates of the front and rear airbags are substantially parallel to corresponding lower end plates of the front and rear airbags.

11. The apparatus of claim 7 wherein the lower frame pivot axis of the right and left parallel link assemblies is provided by a rock shaft extending from the right parallel link assembly to the left parallel link assembly, the rock shaft rotatably mounted to the vehicle frame.
